(19) United States
(12) Patent Application Publication
(10) Pub. No.: US 2006/0153987 A1
(43) Pub. Date: Jul. 13, 2006

(54) Organic bottom anti-feflective composition and patterning method using the same

(76) Inventors: Jae-Hyun Kim, Gyeonggi-do (KR); Chun-Hyuk Lee, Seoul (KR); Hee-Koo Yoon, Gyeonggi-do (KR)

Correspondence Address: FISH & RICHARDSON PC, P.O. BOX 1022, MINNEAPOLIS, MN, 55440-1022, US

(21) Appl. No.: 10/536,512

(22) PCT Filed: Nov. 18, 2003
(86) PCT No.: PCT/KR03/02479

§ 371 Date: May 25, 2005

(30) Foreign Application Priority Data
Nov. 27, 2002 (KR) 10-2002-0074262

(51) Int. Cl. B05D 1/32

(52) U.S. Cl. 427/282

(57) ABSTRACT

The present invention relates to an organic anti-reflective composition and a patterning method using the same, more particularly to an organic anti-reflective composition comprising a crosslinking agent, a light absorbing agent, a thermal acid generator, an organic solvent and an adhesivity enhancer, and a patterning method using the same. The organic anti-reflective composition of the present invention can solve the standing wave effect due to change in optical properties and resist thickness of the bottom film on the wafer, prevent change of critical dimension (CD) due to scattered reflection, and prevent pattern collapse of photosensitizer on top of the organic anti-reflective film, and thus can form stable 64 M, 256 M, 512 M, 1 G, 4 G and 16 G DRAM ultrafine pattern and of improving product yield.

### BACKGROUND OF THE INVENTION

(a) Field of the Invention

The present invention relates to an organic anti-reflective composition and a patterning method using the same, more particularly to an organic anti-reflective composition capable of solving the standing wave effect due to change in optical properties and resist thickness of the bottom film on the wafer, capable of preventing change of critical dimension (CD) due to scattered reflection, and capable of preventing pattern collapse of photosensitizer on top of the organic anti-reflective film, and thus capable of forming stable 64 M, 256 M, 512 M, 1 G, 4 G and 16 G DRAM ultrafine pattern and of improving product yield, and a patterning method using the same.

(b) Description of the Related Art

Currently, 64 M and 256 M DRAM memories are mass-produced in the semiconductor industry. And, the trend is moving toward development and mass-production of 512 M DRAM. With ever increasing integration of memories, critical dimension of resist and its stability in the photolithographic process are becoming more and more important in forming microcircuits.

Especially, the exposure process is very important in semiconductor microcircuit formation and affects resolution and uniformity of photosensitizer pattern. Light with a short wavelength is used in exposure to improve resolution. Recently, light with a wavelength of 248 nm (KrF) is used. The resolution limit of KrF photoresist depends on which equipments are used, but the critical dimension limit is around 0.15 to 0.2 μm.

However, when light with short wavelength is used to improve resolution, optical interference may increase during exposure, and thus pattern profile and dimension uniformity may be deteriorated due to notching, standing wave effect, etc. It is why anti-reflective films are used in the semiconductor substrate.

Anti-reflective films are classified into inorganic anti-reflective film and organic anti-reflective film depending on the material used, and into absorption anti-reflective film and interference anti-reflective film depending on the mechanism. In micropatterning using 365 nm I-line, inorganic anti-reflective film is prevalently used. In general, TiN and amorphous carbon are used for absorption anti-reflective film, and SiON is used for interference anti-reflective film.

In ultramicropatterning using KrF light source, SiON inorganic anti-reflective film has been mainly used. But, there have been efforts to use organic anti-reflective film, recently.

Organic anti-reflective films should satisfy the following basic conditions.

First, the photoresist should not be peeled off by the solvent comprised in the anti-reflective film. For this purpose, the anti-reflective film should be able to form crosslinkage, and no byproducts should be formed by side reaction during crosslinkage.

Second, no chemical (acid or amine) should migrate into or out of the anti-reflective film. If acid migrates out of the anti-reflective film, the bottom of the pattern may be undercut. And, if base such as amine migrates, footing may arise.

Third, the anti-reflective film should be etched faster than the photosensitive film on top of it.

Fourth, the anti-reflective film should be as thin as possible.

Currently, anti-reflective film suitable for ultramicropatterning using KrF light source is unavailable. For inorganic anti-reflective film, there is no material capable of effectively controlling interference at 248 nm (KrF). Recently, efforts are made to use organic anti-reflective film instead of inorganic anti-reflective film.

Therefore, development of new organic anti-reflective composition capable of solving the standing wave effect and diffraction and reflection from the bottom layer during exposure and capable of preventing pattern collapse with good adhesivity to the photosensitizer is highly required.

### SUMMARY OF THE INVENTION

Thus, it is an object of the present invention to provide an organic anti-reflective composition capable of solving the standing wave effect due to change in optical properties and resist thickness of the bottom film on the wafer, capable of preventing change of critical dimension (CD) due to scattered reflection, and capable of preventing pattern collapse of photosensitizer on top of the organic anti-reflective film, and thus capable of forming stable 64 M, 256 M, 512 M, 1 G, 4 G and 16 G DRAM ultrafine pattern and of improving product yield.

It is another object of the present invention to provide a patterning method using said organic anti-reflective composition.

It is still another the present invention to provide a semiconductor device prepared by using said patterning method.

To attain the objects, the present invention provides an organic anti-reflective composition comprising a crosslinking agent, a light absorbing agent, a thermal acid generator, an organic solvent and an adhesivity enhancer represented by the following Chemical Formula 1:
Chemical Formula 1

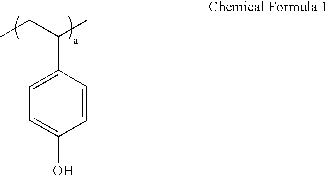

wherein a is the degree of polymerization, ranging from 30 to 400.

The present invention also provides a patterning method comprising the steps of (a) coating said organic anti-reflective composition on a layer to be etched; (b) crosslinking said organic anti-reflective composition by baking to form an organic anti-reflective film; (c) coating photoresist on said organic anti-reflective film and exposing and developing it to form a photoresist pattern; and (d) etching said organic anti-reflective film with said photoresist pattern as mask.

The present invention also provides a semiconductor device prepared by using said patterning method.

### BRIEF DESCRIPTION OF THE DRAWINGS

FIG. 1 is the NMR spectrum of the light absorbing agent prepared in Preparation Example.

FIGS. 2 to 4 show 120 nm L/S patterns according to Examples 1 to 3.

FIGS. 5 to 7 show 120 nm L/S patterns according to Comparative Examples 1 to 3.

### DETAILED DESCRIPTION OF THE PREFERRED EMBODIMENTS

Hereinafter, the present invention is described in more detail.

The present invention is characterized by an organic anti-reflective composition comprising a polyvinylphenol adhesivity enhancer represented by Chemical Formula 1 below, along with a crosslinking agent, a light absorbing agent, a thermal acid generator and an organic solvent, which are used in the conventional organic anti-reflective compositions:

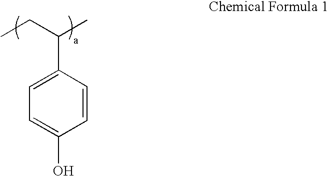

wherein a is the degree of polymerization, ranging from 30 to 400.

When the organic anti-reflective composition of the present invention is coated on the wafer and the thermal process is carried out, acid is generated by the thermal acid generator. The acid activates the crosslinking agent. Then, the light absorbing agent and the adhesivity enhancer represented by Chemical Formula 1 form an organic anti-reflective film with insoluble photosensitizer by crosslinkage.

Also, the adhesivity enhancer represented by Chemical Formula 1 enhances adhesivity of the organic anti-reflective film to the photosensitive film, thereby effectively solving the standing wave effect, capable of preventing change of critical dimension (CD) due to scattered reflection organic anti-reflective film, and capable of significantly preventing pattern collapse of photosensitizer on top of the organic anti-reflective film, and thus capable of forming stable 64 M, 256 M, 512 M, 1 G, 4 G and 16 G DRAM ultrafine pattern and of improving product yield.

Preferably, the adhesivity enhancer represented by Chemical Formula 1 is comprised in 30 to 400 parts by weight for 100 parts by weight of the crosslinking agent. If the content of the adhesivity enhancer represented by Chemical Formula 1 is below 30 parts by weight for 100 parts by weight of the crosslinking agent, crosslinkage becomes insufficient and thus the organic anti-reflective film may be peeled off by the solvent of the photosensing solution, so that it is impossible to form a fine pattern. On the other hand, a content over 400 parts by weight is uneconomical.

When coating photoresist on the organic anti-reflective film, the photoresist should not be dissolved by the solvent comprised in the anti-reflective film. To prevent dissolution of the photoresist, the anti-reflective film should be crossliinked during the baking process.

For the crosslinking agent, any well-known crosslinking agent, such as polyvinyl alcohol (PVA), sodium dichromate (SDC), ammonium dichromate (ADC), 4,4′-diazidobenzalacetophenone-2-sulfonate, 4,4′-diazidostilbene-2,2′-disulfonate and 4′-diazidostilbene-γ-carboxylate may be used. The crosslinking agent having an acetal group is preferable, and a polymer crosslinking agent represented by Chemical Formula 2
below is the most preferable.

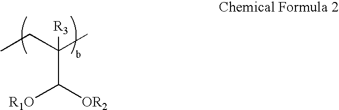

wherein

b is the degree of polymerization, ranging from 10 to 100;

each of R₁ and R₂ is C₁ to C₄ alkyl; and

R₃ is hydrogen or methyl.

To prevent scattered reflection, the organic anti-reflective composition of the present invention should comprise a material absorbing the exposure light. In the present invention, any common light absorbing agent used in conventional organic anti-reflective compositions may be used. Especially, a polymer light absorbing agent represented by Chemical Formula 3 is preferable.

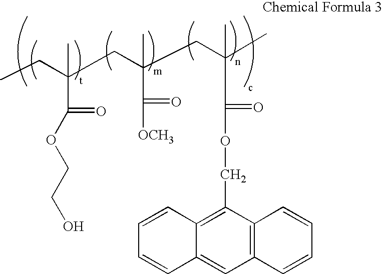

wherein

l, m and n are molar ratios: l ranging from 0.1 to 0.5, m ranging from 0.05 to 0.5, n ranging from 0.1 to 0.7, and e+m+n=1; and

c is the degree of polymerization, ranging from 10 to 400.

In the organic anti-reflective composition of the present invention, content of each component may be adjusted depending on use. The optical absorption coefficient (k value) of the organic anti-reflective composition is determined by the content of each component. Preferably, the light absorbing agent is comprised in 30 to 400 parts by weight for 100 parts by weight of the crosslinking agent. In general, it is recommended to increase the content of the light absorbing agent represented by Chemical Formula 3 to obtain large k value.

The anti-reflective film composition of the present invention comprises a catalyst inducing the crosslinking mechanism. This catalyst is called the thermal acid generator. For the thermal acid generator, any compound used in conventional organic anti-reflective compositions may be used. Especially, 2-hydroxyhexyl p-toluenesulfonate represented by Chemical Formula 4 below is preferable.

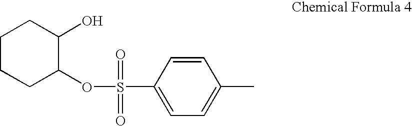

Preferably, the thermal acid generator is comprised in 10 to 200 parts by weight for 100 parts by weight of the crosslinking agent.

The organic anti-reflective composition of the present invention further comprises an organic solvent. For the organic solvent, any one used in conventional organic anti-reflective compositions may be used. Especially, cyclohexane, propyleneglycol methyl ether acetate (PGMEA) and ethyl lactate are preferable.

According to the most preferred embodiment of the present invention, the organic anti-reflective composition comprises: (a) 100 parts by weight of a crosslinking agent represented by Chemical Formula 2 below; (b) 30 to 400 parts by weight of a light absorbing agent represented by Chemical Formula 3 below; (c) 10 to 200 parts by weight of a thermal acid generator represented by Chemical Formula 4 below; (d) 30 to 400 parts by weight of an adhesivity enhancer represented by Chemical Formula 1 below; and (e) 1,000 to 10,000 parts by weight of cyclohexane.

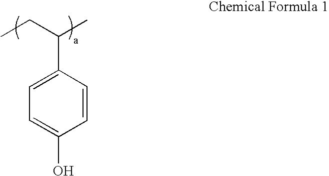

wherein a is the degree of polymerization, ranging from 30 to 400.

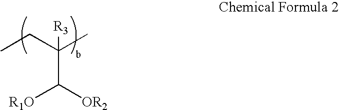

wherein

b is the degree of polymerization, ranging from 10 to 100;

each of R₁ and R₂ is. C₁ to C₄ alkyl; and

R₃ is hydrogen and methyl.

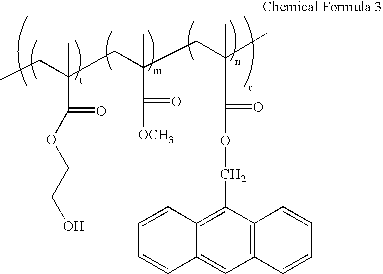

wherein

l, m and n are molar ratios: l ranging from 0.1 to 0.5, m ranging from 0.05 to 0.5, n ranging from 0.1 to 0.7, and e+m+n=1; and

c is the degree of polymerization, ranging from 10 to 400.

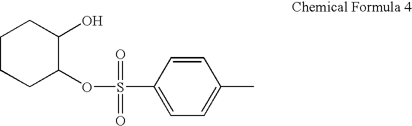

The present invention also provides a patterning method using said organic anti-reflective composition. The method will be described in more detail.

First, said organic anti-reflective composition is coated on top of a silicon wafer or an aluminum substrate to be etched [step (a)]. The composition may be spin-coated or roll-coated, but spin coating is more preferable.

Then, said organic anti-reflective composition is crosslinked by baking to form an organic anti-reflective film [step (b)]. During the baking process, solvent remaining in the organic anti-reflective composition is removed and acid is generated by the thermal acid generator to form crosslinkage between the light absorbing agent and the adhesivity enhancer, and thereby forming an organic anti-reflective film with insoluble photosensitizer.

Preferably, temperature and time of the baking process are sufficient, so that the thermal acid generator is decomposed, the remaining solvent is removed, and the organic anti-reflective composition is sufficiently crosslinked. To be specific, temperature ranging from 150 to 300° C. and time ranging from 1 to 5 minutes are preferable.

Next, photoresist is coated on the organic anti-reflective film, and patterning is carried out by exposing and developing it [step (c)]. In the patterning process, it is preferable to carry out baking before and/or after exposure. In the pattering process, a baking temperature ranging from 70 to 200° C. is preferable.

Also, in the pattering process, far UV such as F₂ laser (157 nm), ArF (193 nm), KrF (248 nm) and EUV (extremely ultraviolet); E-beam; X-ray; or ion beam may be used as exposure light source.

For the developing solution used after exposure, an alkaline compound such as sodium hydroxide, potassium hydroxide, sodium carbonate and tetramethylammonium hydroxide (TMAH) is preferable. Also, an aqueous organic solvent such as methanol and ethanol and a surfactant may be added to the developing solution. Preferably, the wafer is cleansed with ultrapure water after developing.

Then, the organic anti-reflective film is etched with the pattern as etching mask to form an etched pattern [step (d)].

The present invention also provides a semiconductor prepared by said patterning method.

As described above, the organic anti-reflective composition of the present invention can solve the standing wave effect due to change in optical properties and resist thickness of the bottom film on the wafer, prevent change of critical dimension (CD) due to scattered reflection, and prevent pattern collapse of photosensitizer on top of the organic anti-reflective film, and thus can form stable 64 M, 256 M, 512 M, 1 G, 4 G and 16 G DRAM ultrafine pattern and of improving product yield, in the ultrafine patterning process of semiconductor manufacturing.

Hereinafter, the present invention is described in more detail with reference to Examples and Comparative Examples. However, the following Examples and Comparative Examples are only for the understanding of the present invention, and the present invention is not limited by the following Examples and Comparative Examples.

### EXAMPLES

### Preparation Example

### Preparation of Light Absorbing Agent

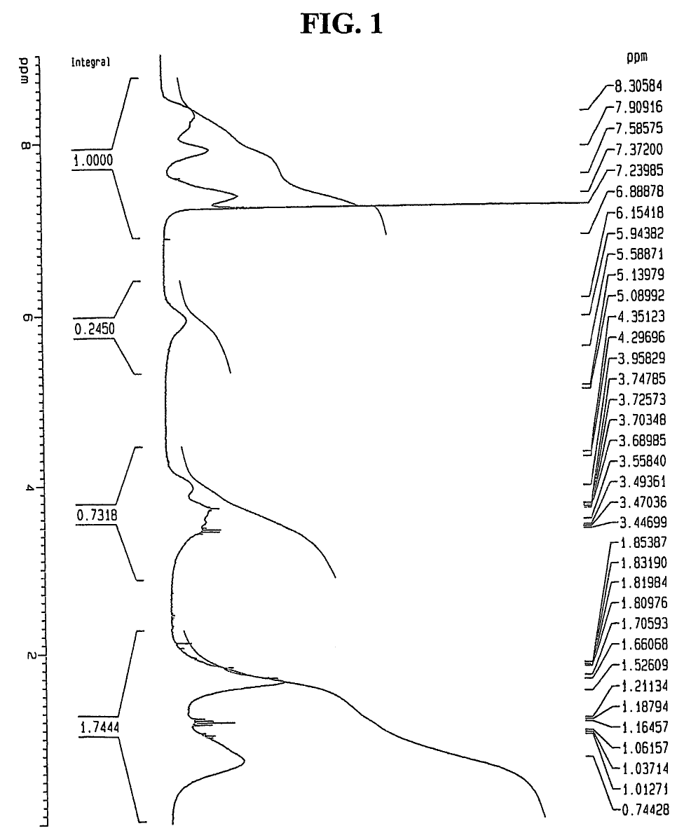

11 g of 9-anthracenemethyl methacrylate, 7 g of 2-hydroxyethyl methacrylate, 2 g of methyl methacrylate and 0.5 g azobisisobutyronitrile (AIBN) were dissolved in a solvent comprising 50 g of tetrahydrofuran and 50 g of methyl ethyl ketone. Then, reaction was carried out at 66° C. for 8 hours. After the reaction was completed, the solution was precipitated in 1 L of ethyl ether and vacuum-dried to obtain poly(9-anthracenemethyl methacrylate/2-hydroxyethyl methacrylate/methyl methacrylate) represented by Chemical Formula 3a below. The yield was 80%. FIG. 1 is the NMR spectrum of the prepared polymer light absorbing agent represented by Chemical Formula 3a.

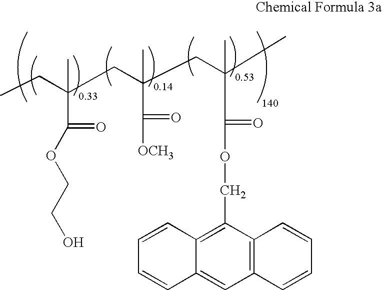

### Examples 1 to 3 and Comparative Examples 1 to 3

An adhesivity enhancer represented by Chemical Formula 1a, a crosslinking agent represented by Chemical Formula 2a below, a light absorbing agent represented by Chemical Formula 3a below and a thermal acid generator represented by Chemical Formula 4a below were dissolved in 39 g of cyclohexane solvent with the content shown in Table 1 below. The solution was filtered through a 0.2 μm microfilter to prepare an organic anti-reflective composition.

The prepared organic anti-reflective composition was spin-coated on a silicon wafer to the thickness shown in Table 1. Then, the wafer was baked at 205° C. for 90 seconds for crosslinking. A photosensitizer (DHK-LX2000, Dongjin) was coated on the crosslinked organic anti-reflective film, and baking was carried out at 100° C. for 90 seconds. Then, the wafer was exposed with a KrF exposure device (ASML), and baked again at 100° C. for 90 seconds.

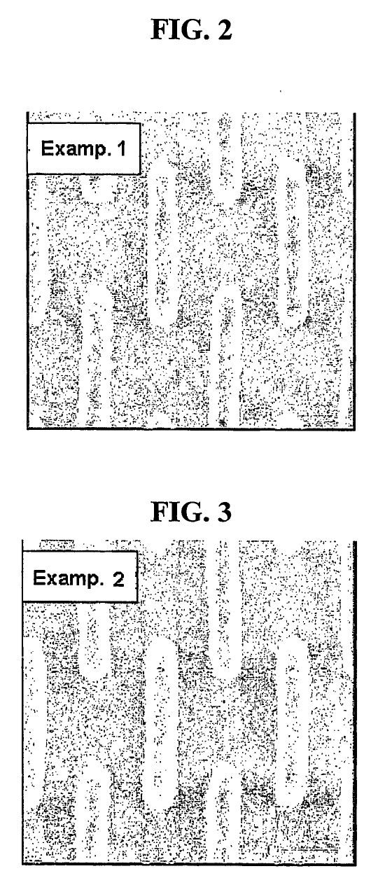

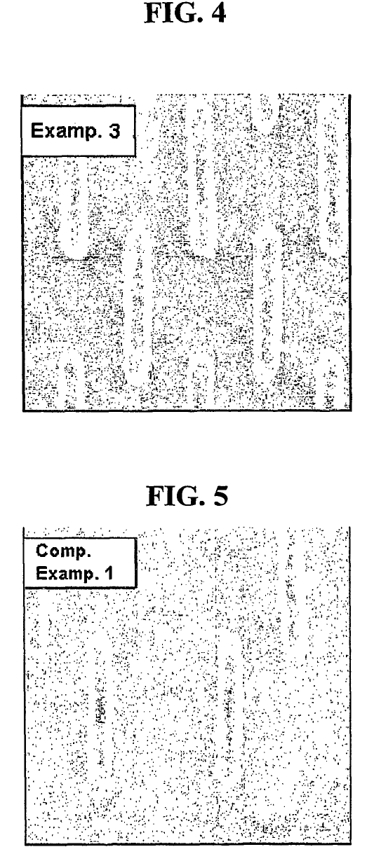

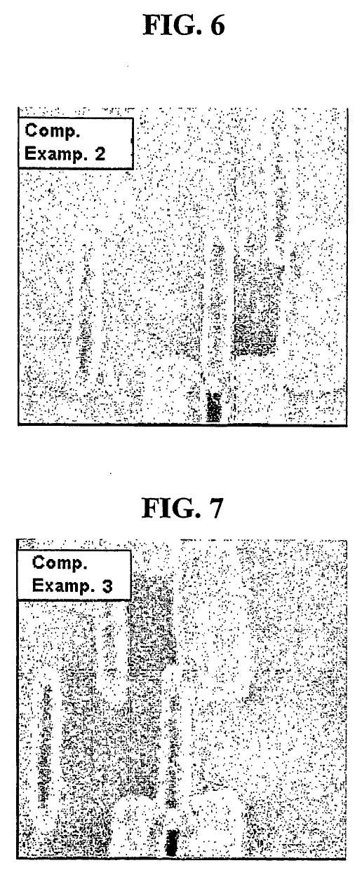

The wafer was developed with 2.38 wt % tetramethylammonium hydroxide (TMAH) developing solution to obtain patterns of FIGS. 2 to 7.

TABLE 1

| | Crosslinking | Light absorbing | Thermal acid | Adhesivity | Thickness | Pattern |
|---|---|---|---|---|---|---|
| Classification | agent (g) | agent (g) | generator (g) | enhancer (g) | (Å) | shape |
| Example 1 | 0.18 | 0.63 | 0.05 | 0.15 | 592 | Good |
| Example 2 | 0.18 | 0.60 | 0.05 | 0.18 | 585 | Good |
| Example 3 | 0.18 | 0.57 | 0.05 | 0.20 | 588 | Good |
| Comparative | 0.36 | 0.63 | 0.05 | — | 597 | Pattern |
| Example 1 | | | | | | collapse |
| Comparative | 0.30 | 0.60 | 0.05 | — | 587 | Pattern |
| Example 2 | | | | | | collapse |
| Comparative | 0.28 | 0.57 | 0.05 | — | 580 | Pattern |
| Example 3 | | | | | | collapse |

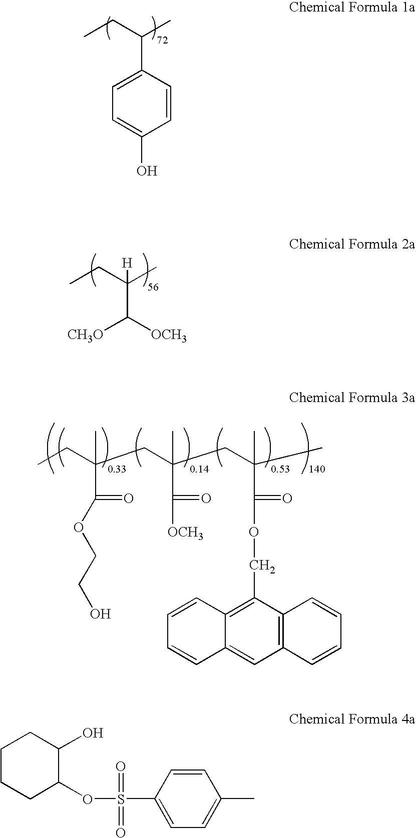

As seen in Table 1 and FIGS. 2 to 7, pattern collapse may be prevented by adding an adhesivity enhancer to the conventional organic anti-reflective composition. It is because adhesivity of photosensitizer to the organic anti-reflective film is improved. As described above, the organic anti-reflective composition of the present invention can solve the standing wave effect due to change in optical properties and resist thickness of the bottom film on the wafer, prevent change of critical dimension (CD) due to scattered reflection, and prevent pattern collapse of photosensitizer on top of the organic anti-reflective film, and thus can form stable 64 M, 256 M, 512 M, 1 G, 4 G and 16 G DRAM ultrafine pattern and of improving product yield, in the ultrafine patterning process of semiconductor manufacturing.

While the present invention has been described in detail with reference to the preferred embodiments, those skilled in the art will appreciate that various modifications and substitutions can be made thereto without departing from the spirit and scope of the present invention as set forth in the appended claims.

1. An organic anti-reflective composition comprising a crosslinking agent, a light absorbing agent, a thermal acid generator, an organic solvent and an adhesivity enhancer represented by the following Chemical Formula 1: 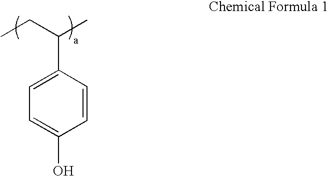
wherein a is the degree of polymerization, ranging from 30 to 400.

2. The organic anti-reflective composition according to claim 1, which comprises:
(a) 100 parts by weight of crosslinking agent;
(b) 30 to 400 parts by weight of light absorbing agent;
(c) 10 to 200 parts by weight thermal acid generator;
(d) 30 to 400 parts by weight of adhesivity enhancer represented by Chemical Formula 1; and
(e) 1,000 to 10,000 parts by weight of organic solvent.

3. The organic anti-reflective composition according to claim 2, wherein said crosslinking agent is the compound represented by the following Chemical Formula 2: 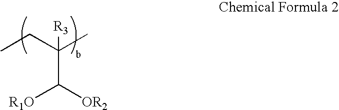
wherein b is the degree of polymerization, ranging from 10 to 100;
each of R₁, and R₂ is C₁ to C₄ alkyl; and
R₃ is hydrogen or methyl.

4. The organic anti-reflective composition according to claim 2, wherein said light absorbing agent is the compound represented by the following Chemical Formula 3: 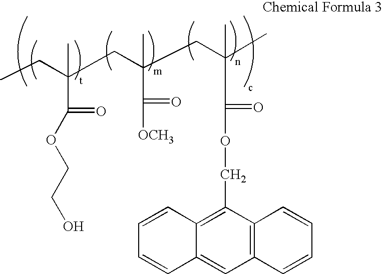
wherein, l, m and n are molar ratios: l ranging from 0.1 to 0.5, m ranging from 0.05 to 0.5, n ranging from 0.1 to 0.7, and l+m+n=1; and
c is the degree of polymerization, ranging from 10 to 400.

5. The organic anti-reflective composition according to claim 2, wherein said thermal acid generator is the compound represented by the following Chemical Formula 4:

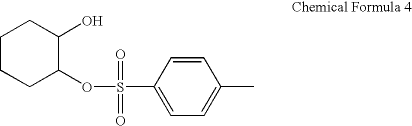

6. A patterning method comprising the steps of:
(a) coating the organic anti-reflective composition according to claim 1 on a part to be etched;
(b) crosslinking said organic anti-reflective composition by baking to form an organic anti-reflective film;
(c) coating a photoresist on said organic anti-reflective film, and exposing and developing the same to form a photoresist pattern; and
(d) etching the organic anti-reflective film with said photoresist pattern as mask.

7. The patterning method according to claim 6, wherein said baking of the step (b) is carried out at 150 to 300° C. for 1 to 5 minutes.

8. The patterning method according to claim 6, wherein baking is further carried out before and/or after exposure of the step (c).

9. The patterning method according to claim 8, wherein said baking is carried out at 70 to 200° C.

10. The patterning method according to claim 6, wherein far UV such as F₂ laser (157 nm), ArF (193 nm), KrF (248 nm) and EUV (extremely ultraviolet); E-beam; X-ray; or ion beam is used as exposure light source in the step (c).

11. A semiconductor device prepared by the method of claim 6.

12. A semiconductor device prepared by the method of claim 7.

13. A semiconductor device prepared by the method of claim 8.

14. A semiconductor device prepared by the method of claim 9.

15. A semiconductor device prepared by the method of claim 10.
